(19) United States
(12) Patent Application Publication
(10) Pub. No.: US 2026/0211746 A1
(43) Pub. Date: Jul. 23, 2026

(54) Dynamic Balancing Between Stability And Cost Optimization In Compute Clusters

(71) Applicant: NetApp, Inc., San Jose, CA (US)

(72) Inventors: Alexander Glikson, Givatayim (IL); Oren Gurfinkel, Rishon Le Zion (IL); Oleg Verhovsky, Ashdod (IL)

(21) Appl. No.: 19/062,463

(22) Filed: Feb. 25, 2025

Related U.S. Application Data
(60) Provisional application No. 63/746,587, filed on Jan. 17, 2025.

(51) Int. Cl. G06F 9/50; G06F 9/54

(52) U.S. Cl. CPC G06F 9/5083; G06F 9/54; G06F 2209/505; G06F 2209/544

(57) ABSTRACT

The disclosure describes a node management service that dynamically adjusts resource allocations for workloads in a compute cluster by balancing cost and stability considerations. The node management service implements a disruption budget that allows for a predetermined level of disruptions of applications within the workload. As the disruption level of the workload approaches the disruption budget, the node management service initiates disruption reduction actions that lower the likelihood of further disruptions.

### CROSS-REFERENCE TO RELATED APPLICATIONS

This application claims priority to U.S. Provisional Patent Application No. 63/746,587 titled “DYNAMIC BALANCING BETWEEN STABILITY AND COST OPTIMIZATION IN COMPUTE CLUSTERS,” filed Jan. 17, 2024, the contents of which is incorporated by reference in its entirety for all purposes.

### BACKGROUND

Orchestration environments like Kubernetes enable dynamic scaling of workloads in a compute cluster. These environments provide the flexibility to adjust resources based on real-time demand thus enabling efficient utilization of resources. However, the dynamic adjustment of resources introduces a risk of potentially compromising workload performance. Ensuring the consistent and reliable performance of a workload, even as demand fluctuates, is referred to as workload stability. Common factors considered in maintaining workload stability include consistent performance, high availability, scalability, resource management, resilience to changes (e.g., node evictions, use of preemptible VMs, etc.), and the like. When effectively designed, workload stability ensures that the workload can handle varying levels of demand without experiencing significant performance degradation, interruptions, or failures.

While the flexibility of these orchestration environments enables efficient resource utilization, this flexibility complicates efforts in maintaining workload stability. Common areas of complication include node evictions, resource scaling, or cost-saving infrastructure options such as preemptible virtual machines (VMs). For example, node evictions occur when a node in the cluster is removed and this can disrupt the workloads running on the node. Preemptible VMs provide significant cost savings (potentially 70% or more). However, the provider can reclaim these VMs in a short period of time (e.g., 2 minutes or less) which can potentially cause sudden workload interruptions.

In order to reduce workload disruption due to container terminations, whether voluntary or forced, container orchestration platforms (such as Kubernetes) offer various mechanisms that can be used by a workload developer. Two common examples, include: 1) minimal capacity, and 2) graceful termination. The minimal capacity (MC) mechanism allows the workload developer to define the minimal capacity that must be always available for an application and ready to serve requests. For replicated scale-out applications (i.e., where an application comprises multiple containers, often hosted on different cluster nodes, with incoming load divided between them), minimal capacity is specified as the desired minimum number of replicas available to serve requests. In Kubernetes, this mechanism is called ‘Pod Disruption Budget’ (PDB) of a workload, and can be defined either as an absolute value, or as a percentage of the total capacity of the workload. Administrative operations, such as draining of a node before the node undergoes removal or maintenance, typically respect PDBs-ensuring that the application has enough capacity to remain up and healthy in presence of node evictions initiated by the administrator or by the auto-scaling logic.

With graceful termination (GT), the application running in the container is notified (e.g., using Linux signal SIGTERM) before the container is forcefully terminated, allowing graceful shutdown. A graceful shutdown typically triggers activities such as cleanup of temporary resources, finishing processing of in-flight requests, persisting in-memory state, de-registering the application replica from some centralized services (e.g., load balancer), etc. A graceful shutdown often reduces or entirely eliminates workload disruption as a result of container termination-assuming that there is enough remaining capacity to handle incoming requests (which can be ensured using minimal capacity mechanism).

Although mechanisms like minimal capacity and graceful termination offer control over workload stability, these mechanisms can be too rigid and static to effectively balance cost with stability. For example, strictly enforcing minimal capacity and graceful termination requirements often reduces the utilization of preemptible VMs and node autoscaling procedures, limiting the availability of cost saving strategies.

### SUMMARY

The disclosure describes a node management service that dynamically balances stability and cost-optimization for a workload running in a compute cluster. The node management service configures a resource allocation in the compute cluster that allows for violations of a stability requirement of the workload. The node management service determines to update the resource allocation based on a comparison between a calculated disruption level of the workload and the workload disruption budget. Upon making the determination, the node management service implements the updated resource allocation. The node management service thus balances stability and cost by allowing for a controlled level of violation of the stability requirement, alleviating the aforementioned issues.

### BRIEF DESCRIPTION OF THE DRAWINGS

FIG. 1 illustrates a computing environment in an implementation.

FIG. 2 illustrates a resource allocation process in an implementation.

FIG. 3 illustrates another resource allocation process in an implementation.

FIG. 4 illustrates another resource allocation process in an implementation.

FIGS. 5A and 5B illustrate user interfaces in an implementation.

FIG. 6 illustrates an operation sequence in an implementation.

FIG. 7 illustrates a compute cluster in an implementation.

FIG. 8 illustrates a computing system suitable for implementing the various operational environments, architectures, environments, processes, scenarios, sequences, and frameworks discussed below with respect to the other Figures.

### DETAILED DESCRIPTION

As organizations adopt cloud-based container orchestration platforms like Kubernetes to achieve scalable and cost-effective deployments, they face challenges reducing compute costs while maintaining reliable workload performance. To save on costs, organizations often rely on cluster auto-scaling (where compute nodes are dynamically added and removed from a compute cluster according to resource demands) and cheaper preemptible virtual machines offered by cloud providers, both of which introduce frequent node churn, causing instability.

Node churn refers to frequent scaling up and down of compute nodes in a cluster (e.g., resulting from the use of cluster auto-scaling), which saves on cost but may impact workload performance. Specifically, the removal of nodes from the cluster (whether voluntary due to load reduction or involuntary due to provider interruptions or reclamation of preemptible compute nodes) can lead to sudden termination of running workload containers. While orchestration platforms (e.g., Kubernetes) provide mechanisms such as minimal capacity requirements and graceful termination to mitigate disruptions, adherence to these strategies can reduce the availability of cluster autoscaling and the use of preemptible nodes (compute nodes implemented on preemptible VMs). Traditional approaches strictly enforce stability requirements (such as graceful termination and minimal capacity as described further below), preventing organizations from taking advantage of cost-saving measures like using preemptible nodes or draining nodes to reschedule pods onto cheaper nodes. On the flip side, overly aggressive cost-optimization without consideration of stability constraints may lead to unacceptable service disruptions.

In contrast, the disclosure introduces a node management service that dynamically balances cost optimization and workload stability by establishing a disruption budget (also known as a Workload Disruption Budget or WDB) which quantifies the acceptable level of service interruptions or stability requirement violations for a workload over a pre-determined time period (e.g., hour, day, week, etc.). Achieving complete workload stability often comes at a premium, and organizations often find trading a modest degree of workload stability for significant cost savings an acceptable trade off. For example, a service level agreement (SLA) may stipulate that an application must maintain 99.9% availability, effectively allowing for up to ten minutes of downtime per week. By accepting a brief period of potential unavailability within the constraints of the SLA requirements, an organization can achieve cost-saving measures while still preserving an adequate level of uptime and reliability.

To perform this balancing, the node management service continuously monitors the state of a workload in the compute cluster, tracking violations of stability requirements (e.g., minimal capacity requirements and graceful termination) to calculate a disruption level. This disruption level may be calculated in various ways; for example, in one implementation the disruption level is a number of violations of the minimal capacity or graceful termination parameters. When this level grows too high (e.g., exceeding a set threshold percentage of the disruption budget) the node management service proactively triggers corrective actions to reduce further disturbances. Such actions might include shifting workloads away from preemptible nodes or redistributing pods across multiple nodes to lessen the impact of potential failures. Conversely, when the disruption level remains well within the acceptable range of the budget, the node management service engages in cost-saving actions, like consolidating workloads on preemptible machines or draining nodes (i.e., migrating pods off a node in preparation for removing the node from the cluster) even if the consolidation may result in violations of workload stability requirements such as minimal capacity and graceful termination. In this manner, the node management service strikes a balance between workload stability and cost efficiency by allowing for a controlled level of workload disruptions.

It is noted that the workflow disruption budget may define a number of violations of stability requirements such as minimal capacity and graceful termination, according to some implementations. Violations of these stability requirements may not always result in an actual application outage; for example, where the minimal capacity parameter specifies 10 pods, and only 9 pods are running in the workload, the stability requirements may while the application continues to operate. However, these violations may cause reduced performance. However, sometimes violations of the stability requirements may cause an application outage (for example, where the minimal capacity parameter is one pod and the number of active pods falls to zero). In any case, by allowing the stability requirements to be violated, the workflow management service tolerates some level of decreased application performance or even sometimes application outages in order to balance stability and cost efficiency.

Various embodiments of the present technology provide for a wide range of technical effects, advantages, and/or improvements to computing systems and components. For example, various embodiments may include one or more of the following technical effects, advantages, and/or improvements: 1) non-routine and unconventional dynamic implementation of a disruption budget for a workload in a compute cluster; 2) non-routine and unconventional operations for balancing cost and stability of a workload in a compute cluster 3) dynamic modification of a resource allocation for a workload based on a disruption level and a disruption budget and/or 4) non-routine and unconventional use of workload stability requirements including allowance of minimum capacity and graceful termination violations.

For example, by allowing some violations of stability requirements to occur, the resource consumption required to spread workloads across multiple nodes and move workloads to new nodes is avoided, delayed, or otherwise reduced, which saves energy, costs, and time. For example, workloads may be entirely implemented in a single compute node. Although this arrangement creates a higher likelihood of disruption, this use of a single compute node is more resource efficient than spreading workloads across multiple compute nodes. The workload disruption budget provides a way for the node management service to make intelligent resource allocation decisions that are now expanded with a view of cost and workload stability.

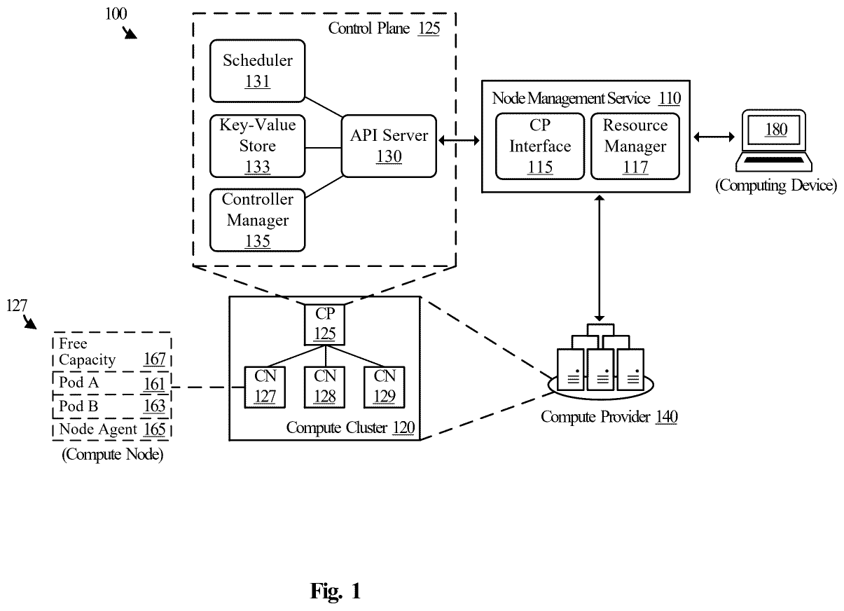

FIG. 1 illustrates compute environment 100 in an implementation. Compute environment 100 includes node management service 110, control plane 125, compute cluster 120, compute provider 140, and computing device 180. Node management service 110 is in communication with control plane 125 and compute provider 140. Control plane 125 operates in compute cluster 120. However, it is noted that in various implementations compute environment 100 may include different or additional components not listed here for brevity.

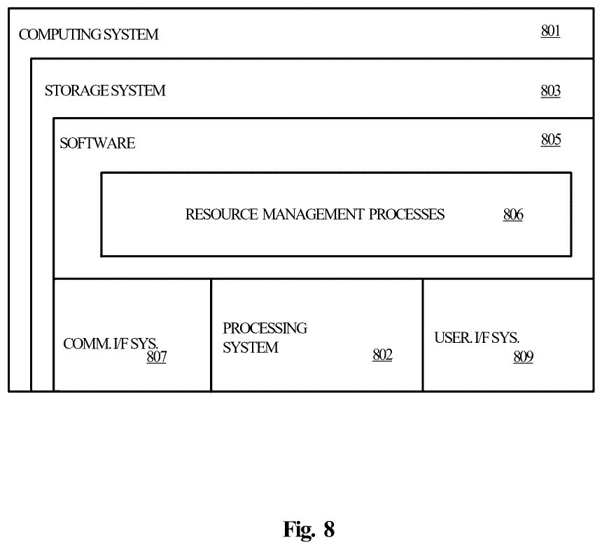

Node management service 110 is representative of a software service for managing compute nodes 127, 128, 129 in compute cluster 120. Node management service 110 may be a cloud-based service or may operate from one or more servers, which may be represented by computing system 801 of FIG. 8. Node management service 110 may be integrated into compute provider 140 (e.g., as a service offered by compute provider 140) in some implementations. In other implementations, node management service 110 may be a third-party or standalone service. Node management service 110 interfaces with compute cluster 120 via API server 130 of control plane 125. Node management service 110 includes control plane interface 115 and resource manager 117. However, it is noted that in various implementations, node management service 110 may include different or additional components not listed here for brevity.

Resource manager 117 is representative of a controller in node management service 110 that performs node scaling and pod distribution actions for workloads in compute cluster 120. These actions may be initiated based on disruption budgets for workloads and stability requirements for the workloads. Resource manager 117 performs resource allocation actions for workloads to dynamically balance between cost efficiency and stability, as discussed in greater detail below in relation to processes 200, 300, and 400.

Control plane interface 115 is representative of a service such as an API layer that interfaces with API server 130 of control plane 125. Control plane interface 115 is configured to receive workload scaling and optimization requests from API server 130 and to provide updates to API server 130 regarding node and pod management, including actions initiated by resource manager 117 based on the disruption budget. Control plane interface 115 provides updates to key-value store 133 via API server 130. These updates may include updates to metadata of compute nodes 127, 128, 129 indicating updates to node status (such as updating the status to “draining” to mark the compute node for pod eviction) and updates to pod requirements (such as preventing or allowing deployment of the pod on a preemptible node). The decisions made by resource manager 117 thus influence the placement of pods determined by control plane 125.

Control plane 125 represents an orchestration platform that manages and coordinates the resources within compute cluster 120. Control plane 125 may operate in one or more nodes of compute cluster 120. Control plane 125 may be a Kubernetes control plane in some implementations. However, it is noted that the concepts described herein are not limited to Kubernetes and may be applied to other orchestration platforms. Control plane 125 includes scheduler 131, key-value store 133, and controller manager 135. However, it is noted that in various implementations, control plane 125 may include different or additional components not listed here for brevity.

Scheduler 131 is configured to schedule pending pods to compute nodes 127 based in part on decisions made by resource manager 117 regarding disruption budgets and stability requirements. Scheduler 131 reads data from key-value store 133 (as defined by node management service 110 for example, or manually by a user), which includes standard resource capacities as well as metadata updates provided by control plane interface 115. This data helps scheduler 131 identify pods that are ready for scheduling, as well as compute nodes 127, 128, 129 that have sufficient available compute capacity and characteristics (e.g., preemptible vs. non-preemptible) accommodate the pending pods.

Key-value store 133 represents a data store that holds metadata parameters used to orchestrate and manage the state of compute cluster 120, including the lifecycle of pods and the stability characteristics of compute nodes 127. This metadata is used by scheduler 131 to place pods in the workload on compute nodes 127. Key-value store 133 may be updated by node management service 110 to perform resource allocation. For example, node management service 110 may update metadata of a workload in key-value store 133 to allow or disallow deployment on preemptible nodes. Key value store 133 may also contain metadata indicative of violations of the minimal capacity and graceful termination parameters. For example, each time a graceful termination or minimum capacity parameter is violated, controller manager 135 may write a status update or event indicating the violation in key-value store 133.

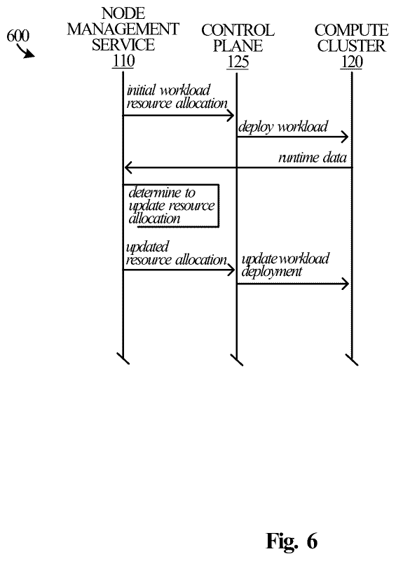

Controller manager 135 represents a suite of controllers that continuously observe the state of compute cluster 120 through key-value store 133 and adjust cluster operations to match desired configurations. Controller manager 135 may be represented by controller manager 630 of FIG. 6.

Compute cluster 120 is representative of a cluster of compute nodes 127, 128, 129 orchestrated by control plane 125. Compute cluster 120 may be, for example, a Kubernetes cluster, however it is noted that the described technology is applicable to clusters in other orchestration platforms. Control plane 125, described above, may be a service operating in one or more compute nodes 127, 128, 129 of compute cluster 120. While three compute nodes 127, 128, 129 are shown in FIG. 1 for simplicity, compute cluster 120 may include any number of compute nodes 127, 128, 129.

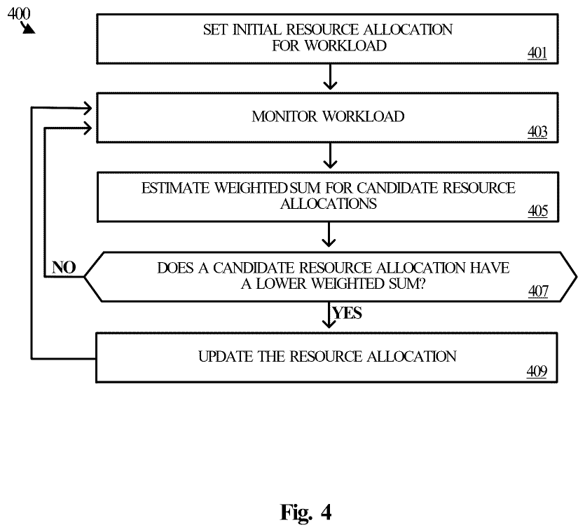

Compute nodes 127, 128, 129 may be implemented as virtual machines or physical servers (e.g., computing system 401 shown in FIG. 4), depending on the deployment. These resources may be provisioned from compute provider 140, which typically offers both preemptible (spot) and non-preemptible VMs. Preemptible VMs provide significant cost savings (e.g., 70% or more) but carry the risk of unexpected interruptions: the compute provider may reclaim these virtual machines at any time, typically with only a brief advance notice period (e.g., two-minute notice). Non-preemptible VMs, on the other hand, offer greater reliability (as they have a significantly decreased likelihood of disruption compared to preemptible VMS) but come at a higher cost. Node management service 110 leverages these options within the framework of the disruption budget. For example, node management service 110 may strategically place workloads with a disruption level well below the workload disruption budget to preemptible VMs to minimize costs, while those nearing the disruption budget are shifted to non-preemptible VMs to maintain stability.

FIG. 1 includes a view of compute node 127 utilization and free capacity, which may be representative of each compute node 127, 128, 129 of compute cluster 120. Compute node 127 may be a virtual machine for running processes, including pods 161, 163, and node agent 165. While two pods are illustrated in FIG. 1 for brevity, compute node 127 may run any number of pods. Allocatable capacity 167 represents currently unutilized resource of compute node 127, allowing scheduler 131 to schedule additional pods to compute node 127.

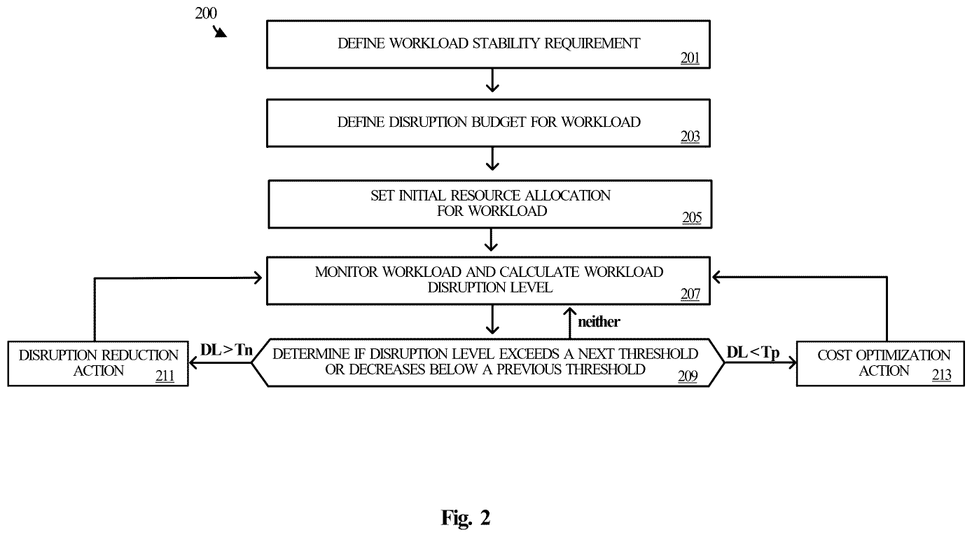

Pods 161, 163, as referenced herein, are deployable units of computing within a container orchestration platform such as Kubernetes. Each pod encapsulates one or more containerized applications. A workload may consist of multiple pods (e.g., pod replicas in a ReplicaSet of Kubernetes) that run concurrently in compute cluster 120 to meet usage demands. Resource manager 117 collects information about pods running in compute cluster 120 to determine a level of disruption of the workload, including violations of graceful termination and minimum capacity requirements. The level of disruption (also referred to as a violation level) may refer to the number of disruptions of minimum capacity and graceful termination, or a weighted sum of the violations of minimal capacity and graceful termination, as described in further detail in relation to process 200 of FIG. 2 below.

Resource manager 117 utilizes this data to make informed decisions about whether resource allocations need to be updated, as described in greater detail below in the discussion of processes 200, 300, 400. Specifically, resource manager 117 may determine whether to switch to a more cost effective resource allocation (e.g., relying preemptible compute nodes 127, 128, 129) or a more stable resource allocation (e.g., introducing a spread constraint to spread the workload across multiple compute nodes 127, 128, 129). Pods are scheduled to compute nodes 127, 128, 129 by control plane 125. Each compute node 127 in compute cluster 120 may host one or more pods from various workloads.

Node agent 165, (e.g., Kubernetes Kubelet), is configured to report on the status of processes running on compute node 127 (e.g., pods 161, 163). Node agent 165 identifies the status of pods 161, 163 (e.g., whether the pod is starting up, running, deleted, etc.) and reports this status to resource manager 117. Resource manager 117 in turn utilizes this information to calculate the level of disruption. For example, where resource manager 117 may calculate the number of running pods in the workload based on the reported status, to determine if the minimal capacity measure is being met.

Compute provider 140 represents a source of compute resources, including preemptible and non-preemptible virtual machines (VMs) that host compute nodes 127, 128, 129. These VMs may be operated from servers distributed across one or more geographic locations and are made available to customers, such as workload application owners, for use in compute clusters like compute cluster 120. In some implementations, node management service 110 may be provided by compute provider 140, in which case node management service 110 is integrated into compute provider 140. In other implementations, node management service 110 may be offered by a third party, independent of compute provider 140. Examples of compute providers include Amazon Web Services, Google Cloud, IBM Cloud, and others.

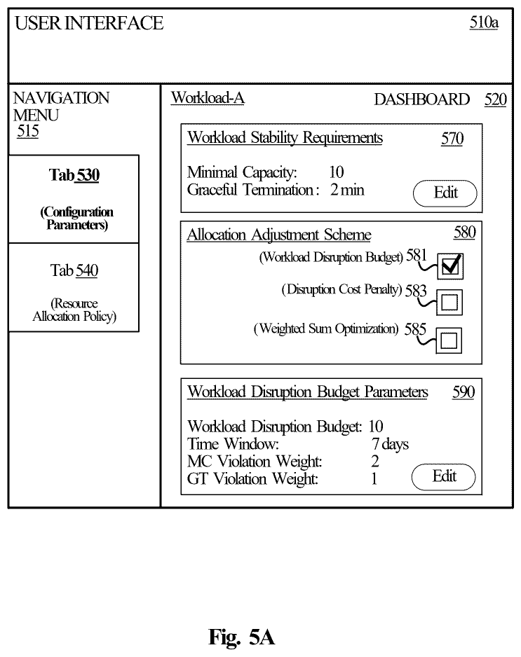

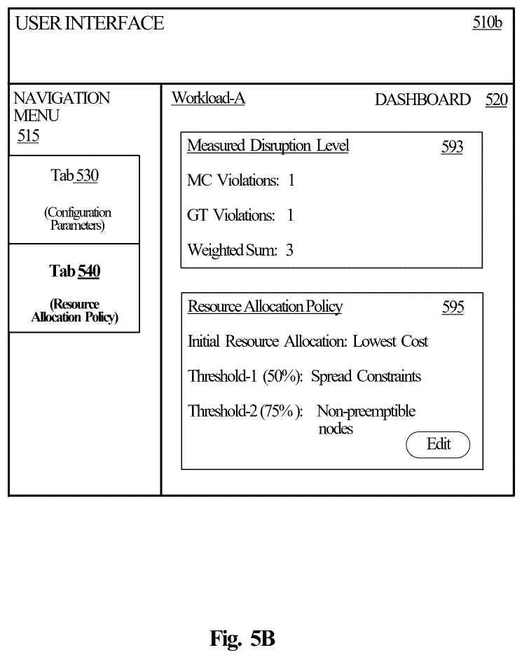

Computing device 180 is representative of a computing device by which a user or customer interfaces with node management service 110. Computing device 180 may be a personal computer, laptop, mobile device, tablet, etc. Computing device 180 may be represented by computing system 801 of FIG. 8. Node management service 110 provides a user interface (e.g., user interfaces 510a, 510b of FIGS. 5A, 5B) via which a user may configure workloads in compute cluster 120, including configuring a workload stability policy, as described further below in the discussion of FIGS. 5A and 5B.

FIGS. 2-4 illustrate processes 200, 300, 400 for balancing stability and cost efficiency for workloads in compute cluster 120 according to various implementations. Process 200 utilizes a workload disruption budget, process 300 utilizes a cost penalty for workload disruptions, and process 400 utilizes a weighted sum of resource allocation costs and workload disruption levels. In each of processes 200, 300, 400, node management service 110 tolerates a certain level of workload disruptions to balance stability and cost efficiency. Node management service 110 may implement any combination of processes 200, 300, 400 in various implementations. Node management service 110 may provide a user interface (such as user interface 510a of FIG. 5A) to allow the user to choose between processes 200, 300, 400. Each of processes 200, 300, 400 is discussed in turn below.

FIG. 2 illustrates a resource management process performed by node management service 110, represented by process 200. Process 200 is employed by a computing device to provide resource management, an example of which is provided by computing system 801 of FIG. 8. Process 200 may be implemented in program instructions (software and/or firmware) by one or more processors of the computing device. The program instructions direct the computing device to operate as follows, referring parenthetically to the steps in FIG. 2.

To begin, node management service 110 defines a workload stability requirement for a workload in compute cluster 120 (step 201). This stability requirement may include one or both of “minimal capacity” and “graceful termination” parameters, which may be utilized by orchestration platforms such as Kubernetes to maintain application reliability. In general, stability requirements are specific quantified constraints associated with a workload to maintain acceptable levels of performance and availability during events like node scaling or evictions. Stability requirements guide control plane 125 in resource allocation and scheduling decisions to provide stability of application performance.

In some implementations, the minimal capacity parameter specifies a baseline number of pods in the workload (e.g., pod replicas) to provide that the workload can continue serving requests effectively. Control plane 125 enforces the minimal capacity by limiting the number of pods that can be taken down at a given time, providing that the number of pods in the workload running in compute cluster 120 does not drop below the specified minimal capacity (referred to in control plane 125 as the Pod Disruption Budget or PDB). Node management service 110 also utilizes the minimal capacity to guide resource allocation decisions. For instance, node management service 110 may refrain from draining a compute node 127 (removing all pods from the compute node 127 in preparation for scale-down) if doing so would result in a violation of the minimal capacity parameter. However, as described further below, node management service 110 may make resource allocation decisions that allow for a controlled level of violations of the minimal capacity parameter to balance cost and stability.

In some implementations (e.g., where the workload includes only a single pod or a fixed number of pods), the minimal capacity may be defined as the minimal amount of computing resources (e.g., CPU and memory) allocated to each pod in the workload. For example, a minimal capacity requirement could specify that each pod in a workload should have at least 1 CPU and 4 GB of memory. Node management service 110 may enforce this minimal capacity by configuring resource request values of the workload with at least the minimal capacity values. However, node management service 110 may at times configure the workload at less than the minimal capacity requirement in order to reduce cost (i.e., where the resource request values are smaller, each pod reserves less resources of a compute node 127, thus allowing more pods to be deployed to a given compute node 127). Where node management service 110 sets the request values lower than the minimal capacity parameter, this may count as a violation of the minimal capacity parameter.

The graceful termination parameter provides that workloads shut down smoothly during pod or node terminations. The graceful termination parameter defines an amount of time allotted to pods in the workload to shut down before node eviction. Control plane 125 enforces graceful termination by sending a termination signal to the application running within the pod, allowing a time period (at least as long as the graceful termination parameter) during which the application can complete its operation and wind down. However, compute provider 140 may give an advance notice of reclamation of a preemptible compute node that is not long enough to satisfy the graceful termination requirements of certain pods, leading to violations of the graceful termination parameter. To prevent such violations, node management service 110 may restrict pods with graceful termination parameters to non-preemptible nodes (i.e., compute nodes 127 implemented on non-preemptible or dedicated VMs) or to preemptible nodes that provide adequate advance notice to satisfy the graceful termination requirement (e.g., a preemptible node that gives a 2 minute reclamation notice may be sufficient for workloads with a graceful termination requirement of 1 minute). Node management service 110 may also refrain from performing node draining if doing so would result in graceful termination violations. Nevertheless, as described further below, node management service 110 may make resource allocation decisions that allow for a controlled level of violations of the graceful termination parameter, to balance cost and stability.

The stability requirements (including minimal capacity and graceful termination parameters according to some implementations) can be set by a user configuring the workload, such as a developer, application owner, or cluster administrator. These parameters may be explicitly specified during the deployment of the workload in the compute cluster, based on the workload's performance requirements, expected traffic patterns, and service level agreements (SLAs). For example, an administrator might define a minimal capacity parameter to ensure that at least two replicas of a critical application are always running or configure a graceful termination parameter to provide a specific grace period for clean shutdowns. In some implementations, node management service 110 may automatically define or adjust these parameters based on observed workload behavior and historical data. For instance, node management service 110 might analyze traffic patterns, failure rates, or pod resource utilization over time to determine appropriate minimal capacity and graceful termination requirements for each workload. For example, where node management service 110 identifies that an application in the workload experiences higher-level of traffic at certain times of day, node management service 110 may set a higher number for minimum capacity (e.g., raising the minimum capacity from 10 to 15) during these specific times.

Node management service defines a disruption budget for the workload (step 203). This disruption budget indicates a maximum level of violations of the stability requirement during a pre-defined time window. For example, the disruption budget may indicate a maximum number of violations of minimal capacity and graceful termination during a predefined time window (e.g., 1 day, 7 days, 30 days, etc.). The disruption budget may also be referred to as a violation budget.

The disruption budget can be defined in various ways in different implementations. In one implementation, the disruption budget may specify the number of allowed violations within the predefined time window. For example, the disruption budget might allow up to five total violations of minimal capacity and/or graceful termination within a one-week period.

In another implementation, the disruption budget may define a weighted sum of violations to account for varying impacts of different types of stability violations. For instance, a violation of minimal capacity might be assigned a higher weight than a violation of graceful termination due to its potentially greater impact on workload availability, as explained further below.

Node management service 110 sets an initial resource allocation for the workload (step 205). This initial resource allocation is configured to allow for potential violations of the stability requirement, such as minimal capacity and graceful termination. To do so, node management service 110 updates one or more workload parameters (e.g., removing or disabling spread constraints and affinity rules) and writes these updated parameters to key-value store 133 in association with the workload. This can result in all pods of the workload being scheduled to a single preemptible compute node 127. For example, node management service 110 may configure the workload to allow for distribution of all pods in a workload to a single preemptible compute node 127 (e.g., by setting a workload configuration without a spread constraint, for example). A spread constraint is a workload parameter providing that pods within a workload are distributed across multiple compute nodes to reduce the impact of node disruption. For instance, a spread constraint might specify that no more than two pods from the same workload can be scheduled on any single compute node, ensuring that pods are dispersed across multiple nodes. In step 205, node management service 110 may implement the initial resource allocation without a spread constraint (thus allowing any number of pods in the workload to be scheduled on a single compute node 127, 128, 129). While this approach is cost-effective, allocation without a spread constraint increases the severity of workload disruption (e.g., including a high number of violations of the minimal capacity parameter).

The initial resource allocation may be selected as the most cost-effective configuration available, such as scheduling all pods in the workload to a single preemptible compute node 127, 128, 129. In other implementations, the initial allocation may prioritize a resource configuration that is highly optimized for cost while incorporating additional considerations, such as spreading pods across multiple preemptible nodes to reduce the risk of simultaneous failure. For example, node management service 110 may select the initial resource allocation based on a predicted amount of violations of graceful terminations and minimal capacity for different resource allocations. Node management service 110 may select an initial resource allocation that is highly optimized for cost while avoiding a resource allocation that would cause an excessively high number of violations. (E.g., node management service 110 may determine that scheduling all pods in a workload to a single preemptible compute node 127, 128, 129 would cause an excessively high number of violations and opt for a resource allocation distributing pods in the workload to two preemptible compute nodes 127, 128, 129.)

Node management service 110 monitors the workload while the workload runs in compute cluster 120 and calculates a disruption level of the workload (step 207). This disruption level is calculated as a sum of the total number of violations of the stability requirement over a predefined time window (e.g., counting the total number of violations of minimal capacity and graceful termination within the previous week) in some implementations. In other implementations, the disruption level may be calculated as a weighted sum, where minimal capacity violations and graceful termination violations are assigned different weights. For instance, the node management service 110 might calculate the weighted sum by assigning a weight of 1 to each graceful termination violation and a weight of 2 to each minimal capacity violation. In this example, the weighted sum would be: 1*(number of graceful termination violations)+2*(number of minimal capacity violations). The disruption level may also be referred to as a “violation level.”

Continuing with process 200, node management service 110 determines if the calculated disruption level exceeds a next threshold or decreases below a previous threshold (step 209). It is noted that step 209 may be performed iteratively in conjunction with steps 207, 211, and 213 to provide for continuous or repeated optimization of the resource allocation of the workload. Multiple thresholds may be employed to fine-tune actions, such as triggering different responses at various percentages of the disruption budget (where the threshold is understood as a percentage of the disruption budget in an implementation). For example, node management service 110 may take mild corrective actions at a threshold corresponding to 50% of the disruption budget, and more aggressive actions at a threshold corresponding to 75% of the disruption budget. If no threshold is surpassed, process 200 returns to step 207 for continued monitoring of the workload. Each threshold may be a predetermined percentage of the disruption budget in an implementation but may also be represented by numerical values in various implementations.

Node management service 110 determines that the disruption level exceeds a threshold when it is equal to or greater than the corresponding threshold percentage of the disruption budget. For example, with a disruption budget of 10, the 50% threshold is 5, meaning a disruption level of 5 or more exceeds this threshold. Similarly, a disruption level of 8 exceeds the 75% threshold. The disruption level falls below the 75% threshold when the disruption level decreases to 7. Likewise, the disruption level falls below the 50% threshold when the disruption level decreases to 4.

These thresholds and the associated actions taken at each threshold may be defined by node management service 110, and may be configurable by a user (e.g., via element 595 in user interface 510b). A user may define any number of thresholds in a resource allocation policy (e.g., two thresholds at 50% and 75% of the disruption budget, or four thresholds at 25%, 50%, 75%, and 90%). Node management service 110 may increase the aggressiveness of the actions as the disruption level approaches the disruption budget, according to some implementations.

Table 1, provided below, illustrates an exemplary set of thresholds and actions:

TABLE 1

| Action | Category | Threshold |
|---|---|---|
| Limit Node Autoscaling | Mild | 25% |
| Switch Availability Zone | Moderate | 50% |
| Spread Constraint | More Aggressive | 75% |
| Switch to non-preemptible | Most Aggressive | 90% |
| compute node | | |

Table 1 illustrates an example resource allocation policy, with each action posing increasing infrastructure costs yet providing better stability (i.e., reduced chances of future violations of the minimal capacity or graceful termination requirements). The “Limit Node Autoscaling” action (classified as “Mild” and triggered at the 25% threshold) involves refraining from node-draining operations when node management service 110 determines that draining a particular compute node 127, 128, or 129 would cause a violation of minimal capacity or graceful termination. Since node autoscaling is only partially restricted, increased costs may be minimal compared to the other disruption reduction actions.

“Switching Availability Zones” (classified as “Moderate” and triggered at the 50% threshold) involves moving one or more preemptible compute nodes 127, 128, or 129 to a preemptible compute nodes 127, 128, 129 in one or more different availability zones. Switching availability zones can reduce region-specific interruptions, lowering the risk minimal capacity and graceful termination violations. However, switching availability zones can be more expensive, due to costs imposed by compute provider 140 for traffic across different zones, for example.

The “Spread Constraint” option (classified as “More aggressive” and triggered at the 75% threshold) involves configuring the workload such that pods are placed on multiple distinct compute nodes 127, 128, 129. A spread constraint reduces the likelihood that a single node eviction will cause an outage for the entire workload but may increase cost due to a less efficient distribution of the workload (e.g., implementing a workload on one large compute node may be cheaper than implementing the workload on multiple smaller compute nodes).

Finally, the “Switch to Non-Preemptible Compute Node” (classified as “Most Aggressive” and triggered at the 90% threshold) involves migrating some or all pods in the workload to non-preemptible compute nodes 127, 128, 129, substantially reducing or eliminating further disruption but incurring the highest costs.

It is noted that the resource allocation actions described above are exemplary, and node management service 110 may employ various other techniques to increase stability or decrease cost. For example, node management service 110 may perform rightsizing operations that set the resource request values for workloads below the minimal capacity parameter (where the minimal capacity parameter identifies the minimum compute resources such as CPU and memory for a workload).

Continuing with process 200, if the disruption level exceeds a next threshold, node management service 110 executes a disruption reduction action (step 211). The “next threshold” refers to the subsequent level following a previously surpassed limit. For example, after exceeding a 50% threshold, the next threshold might be 75%; if the disruption level is zero, the lowest threshold (e.g., 25%) may be the next threshold. These thresholds and associated disruption reduction actions are illustrated and described with respect to Table 1, above. The goal of the disruption reduction action is to limit further disruptions (e.g., violations of minimal capacity and graceful termination) in a proportionate manner (e.g., with varying levels of aggression depending on how close the disruption level is to the disruption budget).

If the disruption level decreases below a previous threshold, node management service 110 executes a cost optimization action (step 213). It is noted that the time period for calculating the disruption threshold may operate as a “sliding window,” extending over a predetermined span from the present moment. Accordingly, as time progresses without significant disruptions (such as experiencing few disruptions in the past week when the period is set to one week), the overall disruption level may decrease. When the disruption level falls below a threshold that was previously exceeded (which had triggered a disruption reduction action at step 211), node management service 110 performs a cost optimization action. This action may increase the likelihood of future disruptions but aims to achieve cost savings. For example, node management service 110 might increase the use of node autoscaling to allow draining of a compute node 127 without providing the full graceful termination period required for pods on the compute node 127, or schedule pods on preemptible compute nodes 127 even though doing so risks violating the minimal capacity and/or graceful termination requirements.

In some implementations, the cost optimization action may be the inverse of the action taken when the threshold was exceeded. For example, referring to the resource allocation policy set forth in Table 1 above, node management service 110 may: switch from a non-preemptible node to a preemptible node if the disruption level falls below 90%; remove the spread constraint from the workload configuration if the disruption level falls below 75%; move compute nodes to the same availability zone if the disruption level falls below 50%; and expand node autoscaling to allow for performance of node draining that causes workload disruption if the disruption level falls below 25% (i.e. in early termination of pods in the workload that results in violation of the graceful termination parameter). After executing the cost optimization action, node management service 110 returns to step 207 to continuously adjust the resource allocation.

Accordingly, process 200 illustrates that resource allocation is dynamically adjusted based on the level of disruptions or violations of the stability requirements. Node management service 110 can implement a more stable resource allocation when the disruption level becomes too high, as achieved through the disruption reduction actions of step 211, or adopt a more cost-effective resource allocation when the disruption level dips, as achieved through the cost optimization actions of step 213. This iterative process ensures continuous adaptation of resource allocation to optimally balance stability and cost in response to real-time workload conditions.

It is noted that in some implementations, node management service 110 may utilize predictive mechanisms to make the resource allocation determinations. For example, node management service 110 may predict future levels of disruption for the current resource allocation based on various historical factors, including the likelihood that preemptible nodes 127, 128, 129 will be reclaimed by compute provider 140 in the future (e.g., node management service 110 may determine that compute provider 140 is more likely to reclaim a compute node 127 at a certain time of day). Thus, node management service 110 may proactively make determinations to adjust the resource allocation even if the actual disruption level does not surpass a threshold. Proactive techniques are discussed further in the discussion of processes 300, 400 below.

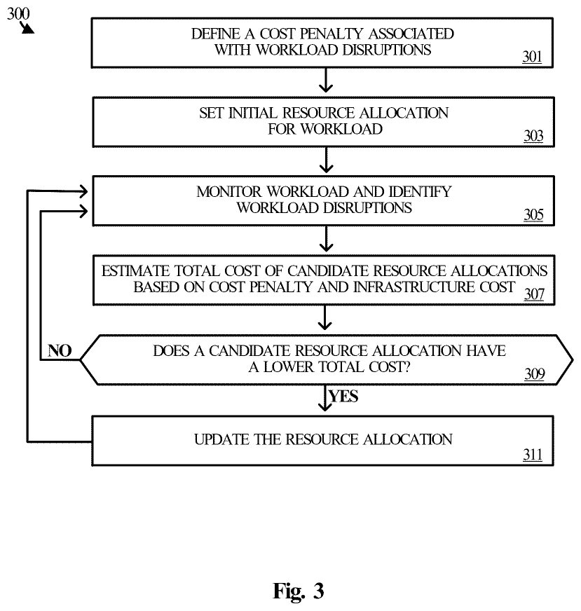

FIG. 3 illustrates a resource management process performed by node management service 110, represented by process 300. Process 300 is employed by a computing device to provide resource management, an example of which is provided by computing system 801 of FIG. 8. Process 300 may be implemented in program instructions (software and/or firmware) by one or more processors of the computing device. The program instructions direct the computing device to operate as follows, referring parenthetically to the steps in FIG. 3.

Node management service 110 defines a cost penalty associated with workload disruptions (Step 301). The cost penalty quantifies the effects of workload disruptions (e.g., violations of graceful termination or minimal capacity) in monetary terms. While workload disruptions may not directly increase infrastructure costs, they can negatively impact workload performance, customer experience, and SLA compliance. Associating a cost penalty with each disruption provides that these negative effects may be quantified by node management service 110.

In some implementations, a flat monetary penalty may be assigned for workload disruptions. This penalty may be identical for both graceful termination and minimal capacity violations (e.g., $50 per violation) or may be differentiated based on impact severity (e.g., $50 for minimal capacity violations and $25 for graceful termination violations). Node management service 110 may determine the cost penalty dynamically based on various factors, including stability requirements defined in service level agreements, historical workload performance data, resource allocation costs (such as the cost of compute nodes 127, 128, 129 in compute cluster 120), among other factors. In some implementations, a user may manually set the cost penalty, for example via a user interface of computing device 180.

Node management service 110 implements an initial resource allocation (step 303). Step 303 may be substantially similar to the initial resource allocation discussed above in step 205 of process 200. In particular, node management service 110 may implement the most cost-effective resource allocation available (such as deploying the entire workload to a single preemptible compute node 127), according to some implementations.

Node management service 110 monitors the workload in compute cluster 120 and identifies workload disruptions (Step 305). As part of Step 305, node management service 110 continuously tracks workload disruptions, including the number of violations of graceful termination and minimal capacity. Node management service 110 tracks the overall cost penalty resulting from the workload disruptions within a sliding time window (e.g., seven days). For example, where node management service 110 identifies two minimal capacity violations with a cost penalty of $50 each, and one graceful termination violation with a cost penalty of $25, the overall cost penalty is $125. Node management service 110 may select the time-period of the sliding-time window based on various factors, including the computing resources needed to switch resource allocations and the frequency with which resource allocations are desired. For example, a longer sliding time window may result in fewer updates to the resource allocation but result in less adaptability (e.g., node management service 110 may take longer to switch to more stable or more cost-effective resource allocations). Conversely, selecting a shorter sliding time-window may result in more rapid changes to resource allocations, but comes at the cost of an increased computing burden to frequently switch resource allocations.

Node management service 110 estimates the total cost for candidate resource allocations based on the overall cost penalty and the infrastructure cost of the candidate resource allocations (Step 307). Node management service 110 may perform this estimation for one or multiple different candidate resource allocations. The candidate resource allocations considered may include any combination of various configurations, including, for example: the utilization of preemptible or non-preemptible compute nodes 127, 128, 129; adding or removing spread constraints for the workload; configuration node autoscaling to allow or disallow node draining that causes workload disruptions; and distribution of compute nodes across different availability zones or the same availability zone. These various examples are discussed above with respect to Table 1.

For each candidate resource allocation, node management service 110 calculates the total cost based on a summation of: (i) the estimated cost penalty for workload disruptions after switching to the candidate resource allocation, and (ii) the projected infrastructure costs for the candidate resource allocation. Infrastructure costs here refer to the expenses of running compute cluster 120 in a given resource allocation, such as the price of VM instances set by compute provider 180. Node management service 110 may estimate infrastructure costs for each candidate resource allocation based on various factors such as advertised rates, and historical cost data. Node management service 110 can employ a range of computational methods to perform this estimation, including machine-learning algorithms that analyze past disruptions and cost patterns. Likewise, node management service 110 may estimate the cost penalty for potential resource allocations based on historical data (e.g., the frequency of terminations of preemptible nodes, and the average startup time for new pods in the workload). To estimate the cost penalty, node management service 110 may utilize various algorithms such as machine-learning based algorithms that project the likelihood of future violations of minimal capacity or graceful termination in candidate resource allocations. Table 2, shown below, provides an illustrative example of the node management service's cost assessment for various resource allocations.

TABLE 2

| | | Infrastructure | Disruption | Total |
|---|---|---|---|---|
| Resource | Infrastructure | Cost | Penalty | Cost |
| Allocation | Change | ($/wk.) | ($/wk.) | ($/wk.) |
| Current | None | 300 | 125 | 425 |
| Candidate A | Change to Non- | 400 | 0 | 400 |
| | preemptible Nodes | | | |
| Candidate B | Remove Spread | 250 | 200 | 450 |
| | Constraints | | | |
| Candidate C | Expand node | 200 | 240 | 440 |
| | Autoscaling | | | |

In Table 2, the current resource allocation is shown at the top. This example illustrates how node management service 110 may consider three alternative resource allocations: Candidate A, Candidate B, and Candidate C. It is noted that Table 3 is exemplary, in various implementations node management service 110 may evaluate a broader set of scenarios. For example, node management service 110 may examine a configuration that removes a spread constraint and switches to non-preemptible compute nodes, or one that changes availability zones while partially limiting node autoscaling. Furthermore, the numeric values in Table 3 represent just one possible example; various resource allocations may have significantly different infrastructure costs and penalties.

In this example of Table 2, the “Current” resource allocation may utilize spread constraints, restricted node autoscaling, and preemptible compute nodes 127, 128, 129, as an example. The infrastructure cost under these conditions may be $300 per week, while the overall disruption penalty is $125 per week (e.g., two minimal capacity violations at $50 each and one graceful termination violation at $25, within the past seven days). The total cost of the current resource allocation is $425, which is the sum of the $300 infrastructure cost and the $125 disruption penalty. Candidate A illustrates the projected costs of a resource allocation that switches to non-preemptible nodes. Node management service 110 may project that no workload disruptions will occur with this configuration (thus projecting a disruption penalty of $0), while the infrastructure costs increase to $400 per week. Overall, the total cost is $400, which is lower than the current resource allocation. Candidate B illustrates the projected cost of a resource allocation that removes spread constraints. While the infrastructure cost is cheaper at $250, the projected cost penalty increases to $200, leading to a higher total cost of $450. Candidate C illustrates a resource allocation expanding the use of node autoscaling (e.g., to allow for node draining that may result in workload disruptions). The projected infrastructure cost is reduced to $200, but the projected disruption penalty increases to $240, leading to an overall cost of $440. In the example in Table 3, node management service 110 would identify Candidate A as the most cost-effective resource allocation.

To perform the estimation, node management service 110 may utilize proactive or predictive techniques, according to some implementations. For example, node management service 110 may, in some implementations, estimate future violations of the stability requirement (e.g., minimal capacity and graceful termination) for the current resource allocation, and use this estimation to calculate future costs of the current allocation (e.g., in the first row of Table 2 above). Node management service 110 may utilize predictive techniques (e.g., using machine-learning algorithms), including, for example, predicting the likelihood that a preemptible compute node 127, 128, 129 will be reclaimed by compute provider 140 at a certain time of day based on previous reclamation data. Thus, node management service 110 may make proactive determinations that are based on predicted future violations instead of or in addition to actual past violations of the stability requirement. For example, node management service 110 may implement a more stable resource allocation (in anticipation of future disruptions) even if the stability requirement has not yet been severely violated.

Continuing with process 300, node management service 110 identifies if a candidate resource allocation has a lower total cost (step 309). In particular, node management service 110 compares the total cost of the current resource allocation (as illustrated in the first row of Table 2 above) to the projected total costs of the other potential resource allocations (e.g., Candidates A, B, and C). Where there is a different resource allocation with a lower estimated cost (e.g., Candidate A in Table 2 above), process 300 proceeds to step 309. If there is not another resource allocation with a lower estimated cost, the current allocation is considered cost efficient and process 300 returns to step 305 to continue monitoring the workload.

If node management service 110 identifies that different resource allocation has a lower total cost, node management service 110 updates the resource allocation (step 311). That is, node management service 110 implements the candidate resource allocation identified as having a lower cost at step 307 (e.g., “Candidate A” from Table 2 above). Where multiple different candidate resource allocations have a lower cost than the current allocation, node management service 110 implements the resource allocation with the lowest total cost, according to some implementations. After step 311, process 300 proceeds to step 305 where node management service 110 continues to monitor the workload and iteratively update the resource allocation when a more cost-efficient candidates are identified. Thus, process 300 provides for cost efficiency (allowing for a certain level of resource disruptions) by assigning a cost value to workload disruptions.

FIG. 4 illustrates a resource management process performed by node management service 110, represented by process 400. Process 300 is employed by a computing device to provide resource management, an example of which is provided by computing system 801 of FIG. 8. Process 400 may be implemented in program instructions (software and/or firmware) by one or more processors of the computing device. The program instructions direct the computing device to operate as follows, referring parenthetically to the steps in FIG. 4.

Node management service 110 implements an initial resource allocation (step 401). Step 401 may be substantially similar to the initial resource allocation discussed above in step 205 of process 200. In particular, node management service 110 may implement the most cost-effective resource allocation available (such as deploying the entire workload to a single preemptible compute node 127), according to some implementations.

Node management service 110 monitors the workload in compute cluster 120 (Step 403). As part of Step 403, node management service 110 continuously tracks workload disruptions, including the number of violations of graceful termination and minimal capacity. This information is used to make resource allocation determinations, as discussed below. Based on the identified workload disruptions, node management service 110 may calculate a weighted sum of the infrastructure cost and the level of disruptions. This weighted sum may be calculated, for example, according to Equation 1 below, where WS represents the weighted sum; CI represents the infrastructure cost; a represents a weighted value for the infrastructure cost; n represents a number of identified disruptions (e.g., minimal capacity and graceful termination violations) over a pre-defined time window (e.g., seven days); and b represents a weighted value for the number of identified disruptions over the predefined time window.

$$W S = a ( CI ) + b ( n ) \qquad Equation 1$$

It is noted that Equation 1 is exemplary and may differ in various implementations. For example, graceful termination violations and minimal capacity violations may be assigned different weights for the summation. Node management service 110 may adjust the resource allocation to minimize this weighted sum, as explained further below.

Node management service 110 estimates the weighted sum for one or more candidate resource allocations. (step 405). For each candidate resource allocation, node management service 110 calculates a weighted sum (e.g., using Equation 1 above). To calculate this weighted sum, node management service 110 projects both the infrastructure cost (CI) of the candidate resource allocation and the projected number of workload disruptions (n) over the pre-defined time window. The projected infrastructure cost (CI) represents the expenses of running compute cluster 120 in a given resource allocation, such as the price of VM instances set by compute provider 180.

Node management service 110 may project infrastructure costs for each candidate resource allocation based on various factors such as advertised rates, and historical cost data. Node management service 110 can employ a range of computational methods to perform this estimation, including machine-learning algorithms that analyze past disruptions and cost patterns. Likewise, node management service 110 may project the number of disruptions (n) for candidate resource allocations based on historical data (e.g., the frequency of terminations of preemptible nodes, and the average startup time for new pods in the workload). To project the number of workload disruptions, node management service 110 may utilize various algorithms such as machine-learning based algorithms that project the likelihood of future violations of minimal capacity or graceful termination based on this historical data. Table 3 shown below, provides an illustrative example of the weighted sum assessment for the current resource allocation and three candidate resource allocations.

TABLE 3

| | | Infrastructure | | | | |
|---|---|---|---|---|---|---|
| Resource | Infrastructure | Cost (IC) | Weight | Disruptions/ | Weight | Weighted |
| Allocation | Change | ($/wk.) | (a) | wk. (n) | (b) | Sum (WS) |
| Current | None | 300 | 0.2 | 3 | 5 | 75 |
| Candidate | Change to | 400 | 0.2 | 0 | 5 | 80 |
| A | Non- | | | | | |
| | preemptible | | | | | |
| | Nodes | | | | | |
| Candidate | Remove | 250 | 0.2 | 4 | 5 | 70 |
| B | Spread | | | | | |
| | Constraints | | | | | |
| Candidate | Expand node | 200 | 0.2 | 5 | 5 | 65 |
| C | Autoscaling | | | | | |

Table 3 illustrates an example in which the weight for the infrastructure cost (a) is assigned the value of 0.2, while the weight for the number of disruptions (b) is assigned a value of 5. The weighted sum is calculated according to Equation 1 set forth above. A user may adjust these weights based on a toleration for the level of disruptions. For example, if a user has a low tolerance for workload disruptions (due to strict availability in SLA agreements, for example), the user may set a higher value for b and and/or a lower value for a. Conversely, if the user has a higher level of tolerance for workload disruptions, the user may set a high value for a and and/or a low value for b. A user may configure the weighted sums, for example via a user interface of computing device 180. The goal of node management service 110 is to implement a resource allocation that minimizes the weighted sum; in the example of Table 3 the resource allocation that minimizes the weighted sum is Candidate C.

To perform the estimation, node management service 110 may utilize proactive or predictive techniques, according to some implementations. For example, node management service 110 may, in some implementations, estimate future violations of the stability requirement (e.g., minimal capacity and graceful termination) for the current resource allocation, and use this estimation to calculate future a future weighted sum of the current allocation (e.g., in the first row of Table 3 above). Node management service 110 may utilize predictive techniques to make this estimation utilizing various factors (e.g., using machine-learning algorithms), including, for example, predicting the likelihood that a preemptible compute node 127, 128, 129 will be reclaimed by compute provider 140 at a certain time of day based on previous reclamation data. Thus, node management service 110 may make proactive determinations that are based on predicted future violations instead of or in addition to actual past violations of the stability requirement. For example, node management service 110 may implement a more stable resource allocation (in anticipation of future disruptions) even if the stability requirement has not yet been severely violated.

Node management service 110 determines if a candidate resource allocation has a lower weighted sum (step 407). Node management service 110 compares the weighted sum for the current resource allocation (e.g., as illustrated in the first row of Table 3) with the weighted sums for the candidate resource allocations. If there is a candidate resource allocation with a lower weighted sum, node management service 110 proceeds to step 409 to update the resource allocation. If there is not a candidate resource allocation with a lower sum, node management service 110 maintains the same resource allocation and proceeds to step 403 to continue monitoring the workload and identify when a change in resource allocations may be appropriate.

If there is a candidate resource allocation with a lower weighted sum, node management service 110 updates the resource allocation to implement the candidate resource allocation with the lower weighted sum (step 409). If there are multiple candidate resource allocations with a lower weighted sum than the current resource allocation, node management service 110 implements the resource allocation with the lowest weighted sum. In the example of Table 3, node management service 110 would implement the expanded node autoscaling of Candidate C. After step 409, process 400 proceeds to step 403 where node management service 110 continues to monitor the workload and iteratively make further resource allocation updates when candidate resource allocations with lower weighted sums are identified.

FIGS. 5A and 5B illustrate user interfaces 510a, 510b of computing device 180 according to some implementations. User interfaces 510a, 510b, illustrate user interfaces in which a user or customer of node management service 110 configures a resource allocation policy for workloads in compute cluster 120. It is noted that user interfaces 510a and 510b illustrate some examples; in other implementations user interfaces on computing device 180 may have different arrangements, different elements, or additional or fewer elements.

FIG. 5A illustrates user interface 510a in an implementation. User interface 510a includes navigation menu 515 and dashboard 520. Navigation menu 515 includes tabs 530, 540. Tab 530 is selectable to navigate to a display where a user may set configuration parameters (as illustrated in FIG. 5A). Tab 540 is selectable to navigate to a display in which a user may set a resource allocation policy (as illustrated in FIG. 5B).

Element 570 illustrates a panel in which a user may view and edit workload stability requirements including minimal capacity and graceful termination. In this example, the workload is configured with a minimal capacity requirement of 10 and a graceful termination requirement of 2 minutes.

Element 580 represents a panel in which a user may select an allocation adjustment scheme. Element 581 (Workload Disruption Budget) may correspond to process 200 described above; Element 583 (Disruption Cost Penalty) may correspond to process 300 described above; while element 585 (Weighed Sum Optimization) may correspond to process 400 described above. Accordingly, a user may select one of elements 581, 583, 585 to implement one of processes 200, 300, 400 for balancing stability and cost efficiency for a workload. In the example in FIG. 5A, then user has selected the “Workload Disruption Budget” scheme, corresponding to process 200.

Element 590 represents a panel in which a user may view and set parameters for the Workload Disruption Budget scheme. In particular, the user can set the Workload Disruption Budget (the total number of allowable disruptions or the weighted sum of allowable disruptions, in this case 10); the time window (the sliding window during which disruptions are counted, in this case 7 days); the MC Violation weight (the weight given to minimal capacity violations when calculating the disruption level based on a weighted sum, in this case 2); and the GT Violation weight (the weight given to graceful termination violations when calculating the disruption level based on a weighted sum, in this case 1).

It is noted that where “Disruption Cost Penalty” or “Weighted Sum Optimization” are selected in element 580, element 590 may present other configurable parameters. For example, for “Disruption Cost Penalty;” element 590 may allow configuration of the cost penalty associated with graceful termination violations and minimal capacity violations. For “Weighted Sum Optimization,” element 590 may allow configuration of the weights used in the weighted sum calculation (e.g., a and b as discussed above in process 400).

FIG. 5B illustrates user interface 510b in an implementation. User interface 510a includes navigation menu 515 and dashboard 520. Navigation menu 515 includes tabs 530, 540, as discussed above in reference to FIG. 5A.

Element 593 illustrates a panel which displays the current level of disruption in compute cluster 120, which may be real-time information provided by node management service 110. Element 593 illustrates the identified number of minimal capacity violations (in this case 1), the identified number of graceful termination violations (in this case 1), and the weighted sum of the minimal capacity and graceful termination violations (in this example the weighted sum is 3; as the minimal capacity violation may have a weight of 2, while the graceful termination violation has a weight of 1).

Element 595 illustrates a panel which displays and provides the ability to configure the resource allocation policy (in this example, according to the workload disruption policy as discussed above in process 200). In this case, the resource allocation policy has two thresholds (50% and 75%). When the disruption level exceeds 50% of the disruption budget, node management service 110 implements spread constraints, and when the disruption level exceeds 75% of the disruption budget, node management service 110 implements non-preemptible nodes. In some implementations, node management service 110 may implement inverse actions when falling below the thresholds (e.g., where the disruption level falls below 50% node management service 110 removes the spread constraints and implements the resource allocation with the lowest cost). The user may edit this policy (e.g., by selecting the “Edit” button). Editing the policy may include changing the threshold percentage values (e.g., changing 75% to 90%) adding or removing an additional threshold (e.g., adding an additional threshold at 50%) and changing the resource allocation actions (e.g., switching from spread constraints to the implementation of nodes in different availability zones).

FIG. 6 illustrates an operation sequence in the context of compute environment 100 in an implementation, represented by sequence 600. Sequence 600 includes node management service 110, control plane 125, and compute cluster 120.

In sequence 600, node management service 110 sets the initial resource allocation for the workload in control plane 125. Setting the initial resource allocation may include configuring parameters in key-value store 133 of control plane 125, for example, parameters allowing pods in the workload to be scheduled to pre-emptible compute nodes 127, 128, 129. Setting the initial resource allocation is described above in relation to step 205 of process 200, step 303 of process 300, and step 401 of process 400. Control plane 125 deploys the workload to compute cluster 120 according to the resource allocation set by node management service 110 (e.g., scheduling pods in the workload to pre-emptible compute nodes 127, 128, 129). Compute cluster 120 provides runtime data to node management service 110. This runtime data may include information about pods status information (e.g., whether a pod is active) obtained from node agent 165 on compute nodes 127, 128, 129. Based on the runtime data, node management service determines to update the resource allocation. This determination may be based on a threshold being exceeded (e.g., as described in relation to step 209 of process 200), whether a candidate resource allocation has a lower total cost (e.g., as described in relation to step 309 of process 300) or whether a candidate resource allocation has a lower weighted sum (e.g., as described in relation to step 407 of process 400). Node management service 110 updates the resource allocation in control plane 125 (as described in relation to steps 211, 213 of process 20, step 311 of process 300, and step 409 of process 400). Control plane 125 updates the workload deployment in compute cluster 120 based on the updated resource allocation (e.g., by scheduling pods in the workload to non-preemptible compute nodes 127, 128, 129 where the updated resource allocation specifies non-pre-emptible compute nodes for the workload).

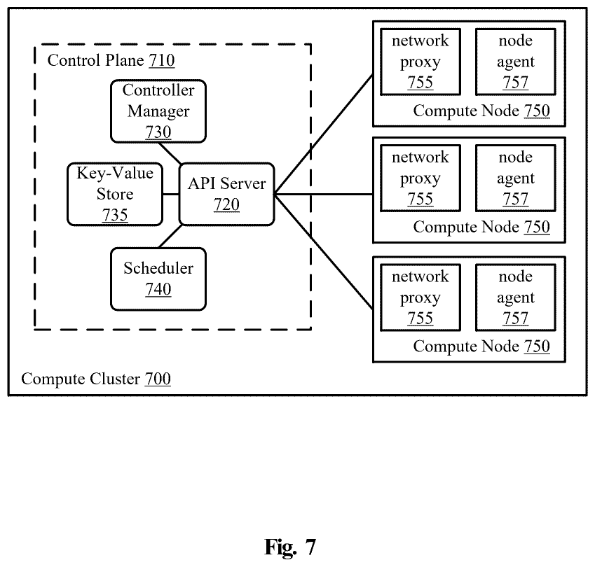

FIG. 7 illustrates compute cluster 700 in an implementation. Compute cluster 700 includes control plane 710 and compute nodes 750. Compute cluster 700 may be a Kubernetes cluster; however, compute cluster 700 may also be representative of various other orchestration platforms. Compute cluster 700 may be representative of compute cluster 120 of FIG. 1.

Control plane 710 is representative of a software service that manages resources in compute cluster 700, and may, for example, be a Kubernetes control plane. Control plane 710 can operate from one or more nodes or virtual machines within compute cluster 700. Control plane 710 includes API server 720, controller manager 730, key-value store 735, and scheduler 740.

API server 720 is a central interface in control plane 710 for processing and validating requests. API server 720 is in communication with compute nodes 750, controller manager 730, key-value store 735, scheduler 740, as well as external clients such as a node management service as described herein. API server 720 processes requests (such as requests to create, update, or delete resources), validates them, and updates the state of compute cluster 700 in key-value store 735. API server 720 may also handle authentication and authorization of client requests, ensuring that only permitted users and services can access or modify cluster resources.

Controller manager 730 is representative of a service that manages controllers to maintain the state of compute cluster 700 by continuously monitoring the current state and reconciling the current state with the desired state as defined in key-value store 735. Controller manager 730 orchestrates tasks to achieve the desired state, such as coordinating the creation or deletion of pods to match the specified number of pod replicas, monitoring the health of compute nodes 750, and initiating replacement or recovery actions for failed nodes.

Key-value store 735, which may be Kubernetes etcd in some implementations, maintains the cluster's configuration data and state information.

Scheduler 740 assigns workloads such as pods to appropriate compute nodes 750. Scheduler 740 makes scheduling decisions based on resource availability, constraints, and policies.

Compute nodes 750 are representative of virtual machines or physical servers on which workloads run. While three compute nodes 750 are shown in FIG. 7 for clarity, it is noted that compute cluster 700 may include any number of compute nodes. Compute node 750 includes network proxy 755 and node agent 757.

Network proxy 755 (e.g., Kube-proxy) is representative of a service running on compute node 750 that maintains network rules on compute node 750 to facilitate communication between services within the cluster. Network proxy 755 manages network routing for service discovery and load balancing, providing that requests to a particular service are directed to one of the corresponding backend pods.

Node agent 757 (e.g., Kubelet) is representative of a service running on compute node 750 that manages the state of pods on compute node 750. Node agent 757 communicates with API server 720 to receive instructions about which pods to run. Node agent 757 performs tasks such as starting, stopping, and managing containerized workloads. Additionally, node agent 757 monitors running pods containers, collects resource usage metrics, and reports on the state of compute node 750 to control plane 710.

FIG. 8 illustrates computing system 801, which is representative of any system or collection of systems in which the various applications, processes, services, and scenarios disclosed herein may be implemented. Examples of computing system 801 include, but are not limited to server computers, web servers, cloud computing platforms, and data center equipment, as well as any other type of physical or virtual server machine, container, and any variation or combination thereof. (In some examples, computing system 801 may also be representative of desktop and laptop computers, tablet computers, and the like.)

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements resource management processes 806, which is representative of the processes discussed with respect to the preceding Figures, such as processes 200, 300, 400. When executed by processing system 802, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may include a microprocessor and other circuitry that retrieves and executes software 805 from storage system 803. Processing system multiple processing devices or sub-systems that cooperate in executing program instructions. Examples of processing system 802 include general purpose central processing units, microcontroller units, graphical processing units, application specific processors, integrated circuits, application specific integrated circuits, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 803 may be implemented as a single storage device but may also be implemented across multiple storage devices or sub-systems co-located or distributed relative to each other. Storage system 803 may comprise additional elements, such as a controller capable of communicating with processing system 802 or possibly other systems.

Software 805 (including resource management processes 806) may be implemented in program instructions and among other functions may, when executed by processing system 802, direct processing system 802 to operate as described with respect to the various operational scenarios, sequences, and processes illustrated herein. For example, software 805 may include program instructions for implementing resource management processes and procedures as described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method comprising:
configuring a resource allocation for a workload in a compute cluster, wherein the resource allocation allows for violations of a stability requirement of the workload;
determining to update the resource allocation based at least on a disruption budget of the workload in the compute cluster and a calculation of a disruption level of the workload, wherein the disruption level quantifies violations of the stability requirement over a pre-defined time window; and
updating the resource allocation in response to the determination.

2. The computer-implemented method of claim 1, wherein:
the determining to update the resource allocation includes determining that the disruption level exceeds a threshold percentage of the disruption budget; and
the updating the resource allocation includes implementing a disruption reduction action.

3. The computer-implemented method of claim 2, wherein the disruption reduction action comprises one or more of:
reducing a use of node autoscaling;
implementing a compute node in the compute cluster in a different availability zone;
introducing a spread constraint to a configuration of the workload such that pods in the workload are distributed across multiple compute nodes; and
deploying one or more pods in the workload to a non-preemptible compute node.

4. The computer-implemented method of claim 1, wherein:
the determining to update the resource allocation comprises determining that the disruption level has decreased below a threshold percentage of the disruption budget; and
the updating the resource allocation comprises implementing a cost optimization action.

5. The computer-implemented method of claim 4, wherein the cost optimization action comprises one or more of:
performing node draining operations; and
placing one or more pods in the workload on preemptible compute nodes.

6. The computer-implemented method of claim 1, wherein the configuring the resource allocation and the determining to update the resource allocation are performed iteratively while the workload runs in the compute cluster.

7. The computer-implemented method of claim 1, wherein the stability requirement comprises one or both of:
a minimal capacity requirement defining a minimum number of pods in the workload running in the compute cluster, and
and a graceful termination requirement defining an amount of time allotted to pods in the workload to shut down before node eviction.

8. The computer-implemented method of claim 1, further comprising, by the one or more computers:
defining the stability requirement for a workload to be scaled up in the compute cluster; and
establishing the disruption budget for the workload, the disruption budget including a maximum number of violations the stability requirement during the pre-defined time window.

9. A system comprising:
one or more processors; and
one or more memories operably coupled to the one or more processors and having stored thereon software instructions that, upon execution by the one or more processors, cause the one or more processors to:
configure a resource allocation for a workload in a compute cluster, wherein the resource allocation allows for violations of a stability requirement of the workload; and
update the resource allocation based at least on a disruption budget of the workload in the compute cluster and a calculation of a disruption level of the workload, wherein the disruption level quantifies violations of the stability requirement.

10. The system of claim 9, wherein: the updating the resource allocation comprises implementing a disruption reduction action.

11. The system of claim 10, wherein the disruption reduction action comprises one or more of:
reducing a use of node autoscaling;
implementing a compute node in the compute cluster in a different availability zone;
introducing a spread constraint to the workload such that pods in the workload are distributed across multiple compute nodes; and
deploying one or more pods in the workload to a non-preemptible compute node.

12. The system of claim 9, wherein: the updating the resource allocation includes implementing a cost optimization action.

13. The system of claim 12, wherein the cost optimization action comprises or more of:
performing node draining operations; and
placing one or more pods in the workload on preemptible compute nodes.

14. The system of claim 9, wherein the configuring the resource allocation and the updating the resource allocation are performed iteratively while the workload runs in the compute cluster.

15. The system of claim 9, wherein the stability requirement comprises one or both of:
a minimal capacity requirement defining a minimum number of pods in the workload running in the compute cluster, and
a graceful termination requirement defining an amount of time allotted to pods in the workload to shut down before node eviction.

16. The system of claim 9, wherein the software instructions comprise further instructions that, upon execution by the one or more processors, cause the one or more processors to:
define the stability requirement for a workload to be scaled up in the compute cluster; and
establish the disruption budget for the workload, the disruption budget including a maximum level of violations the stability requirement during a pre-defined time window.

17. A computer-readable storage media device having program instructions stored thereon, wherein the program instructions, upon execution by one or more processors, cause the one or more processors to:
define, by a node management service, at least one stability requirement for a workload to be scaled up in a compute cluster;
establish a violation budget for the workload, the violation budget indicating a maximum level of violations the stability requirement during a time window;
configure a resource allocation for the workload in the compute cluster, wherein the resource allocation allows for violations of the stability requirement;
determine to update the resource allocation based at least on the violation budget of the workload in the compute cluster and a calculation of a violation level of the workload, wherein the violation level is indicative of violations of the stability requirement over a pre-defined time window; and
update the resource allocation in response to the determination.

18. The computer-readable storage media device of claim 17, wherein:
the determining to update the resource allocation includes determining that the violation level exceeds a portion of the violation budget; and
the updating the resource allocation includes implementing a disruption reduction action.

19. The computer-readable storage media device of claim 17, wherein:
the determining to update the resource allocation includes determining that the violation level has decreased below a portion of the violation budget; and
the updating the resource allocation includes implementing an action to improve cost efficiency in the compute cluster.

20. The computer-readable storage media device of claim 17, wherein the stability requirement comprises one or both of:
a minimal capacity requirement defining a minimum number of pods in the workload running in the compute cluster, and
a graceful termination requirement defining an amount of time allotted to pods in the workload to shut down before node eviction.
